(19) United States
(12) Patent Application Publication
(10) Pub. No.: US 2025/0242333 A1
(43) Pub. Date: Jul. 31, 2025

(54) PREPARATION OF CERIA-BASED EXTRUDATES FOR CATLYST APPLICATIONS

(71) Applicant: CHEVRON U.S.A. INC., San Ramon, CA (US)

(72) Inventors: Oleg A. MIRONOV, Kensington, CA (US); Alexander E. KUPERMAN, Midland, MI (US)

(21) Appl. No.: 19/036,390

(22) Filed: Jan. 24, 2025

Related U.S. Application Data
(60) Provisional application No. 63/626,677, filed on Jan. 30, 2024.

(51) Int. Cl. B01J 23/10; B01J 35/37; B01J 35/61; B01J 35/63; B01J 35/64; B01J 37/00; B01J 37/04; B01J 37/08

(52) U.S. Cl. CPC B01J 23/10; B01J 35/37; B01J 35/613; B01J 35/615; B01J 35/617; B01J 35/618; B01J 35/633; B01J 35/635; B01J 35/638; B01J 35/643; B01J 35/647; B01J 37/0018; B01J 37/04; B01J 37/084

(57) ABSTRACT

A process for producing ceria extrudates is disclosed. The process includes may include mixing ceria, a cellulose ether, and optionally a solvent to form a mixture; extruding the mixture to form an extrudate; and drying and/or calcining the extrudate. The extrudate is suitable as a catalyst or a catalyst support, in particular for conversion of carbon dioxide to value-added products.

### CROSS-REFERENCE TO RELATED APPLICATIONS

This application claims the benefit of U.S. Provisional Application No. 63/626,677, filed on Jan. 30, 2024, the entire contents of which are incorporated herein by reference.

### FIELD

This disclosure relates to the preparation of calcined ceria extrudates and their use as catalysts or catalyst carriers.

### BACKGROUND

Many industrial processes employ catalysts comprising a catalytically active material supported on a shaped body (particle, extrudate) or bound in a shaped body. Examples of such catalysts include supported metals, supported metal complexes, supported organometallics, bound zeolites and bound zeolite-type materials. The shaped bodies used in such catalysts are typically made of refractory inorganic oxides by forming a mixture of one or several sources of the inorganic oxide in a suitable vehicle, such as water and/or an organic solvent. The mixture is then formed into various shapes, generally by extrusion, and subsequently dried and calcined to produce the final shaped body. The shaped particles/bodies are usually referred to as extrudates. US20160228861

[symbol]

Ceria (CeO₂) is potential raw material for the preparation of catalysts for new processes, such as the conversion of carbon dioxide to value-added products. Ceria possesses the desirable redox properties that can be employed in CO₂ conversion which conventional catalyst supports such as alumina or silica lack. The challenge with ceria is that contrary to, for example, alumina, it does not peptize naturally, and requires special procedures and methods to create interparticle bonds that would bind the ceria powders together and allow for practical preparation of extrudates with acceptable mechanical strength.

It would therefore be desirable to prepare a ceria extrudate which has sufficient strength to be of industrial importance.

### SUMMARY

In one aspect, there is provided a process for preparing a porous, extruded ceria-based material, the process comprising: (a) mixing ceria, a cellulose ether, and optionally a solvent, to form a mixture; (b) extruding the mixture to form an extrudate; and (c) drying and/or calcining the extrudate.

In another embodiment, there is provided a porous, extruded ceria-based material obtainable according to the process described herein.

### BRIEF DESCRIPTION OF THE DRAWINGS

FIG. 1 shows photographs of ceria extrudates of Example 1, Example 2 and Example 3 after drying at 200° C.

FIG. 2 shows photographs of ceria extrudates of Example 1, Example 2 and Example 3 after calcination at 900° C.

### DETAILED DESCRIPTION

### Definitions

As used herein, and unless the context dictates otherwise, the following terms have the meanings as specified below.

An “extrudate” refers to an elongate body produced during extrusion.

The term “extrusion” refers to a process of pushing a fluidized material though a die having a desired cross-section.

The term “cellulose ether” refers to a cellulose polymer with the hydrogen of one or more hydroxyl groups in the cellulose structure replaced with an alkyl, hydroxyalkyl, or aryl group.

The term “cellulose” refers to a polysaccharide of glucose monomers.

The term “paste” refers to a solvated powder having a dough-like appearance and consistency. The term “paste” does not imply an adhesive function.

### Production of Ceria Extrudate

In the present process for the preparation of a ceria-based extrudate material, ceria (CeO₂), a cellulose ether and optional solvent are mixed together to form a mixture. The process also includes extruding the mixture to form an extrudate. The process further includes drying and/or calcining the extrudate.

A cellulose ether may be employed in certain embodiments, in amounts sufficient to provide the desired physical attributes and physical integrity to the substrate. Non-limiting examples of cellulose ethers include methylcellulose, hydroxypropyl cellulose (“HPC”), hydroxypropyl methylcellulose (“HPMC”), hydroxyethyl cellulose, and carboxymethyl cellulose (“CMC”). In some embodiments, the cellulose ether is hydroxypropyl methylcellulose. Without intending to be bound by theory, it is thought that cellulose ethers may bind well with ceria and produce an extrudate with superior mechanical strength.

The optional solvent may be any of the suitable solvents known in the art, for example, water, alcohols, ketones, amides, esters, ethers, nitriles, aromatic hydrocarbons, aliphatic hydrocarbons, and combination(s) thereof. In some embodiments, the solvent is selected from the group consisting of water, methanol, ethanol, dimethylformamide, acetone, diethyl ether, acetonitrile, and combination(s) thereof. In some embodiments, the solvent is water. In some embodiments, the solvent is a mixture of two or more solvents. In some embodiments, there is no solvent. Optional components such as acids and bases may be added to the solvent to act as a peptization agent in the preparation of an extrudable paste.

The mixture may include from 1 wt. % to 99 wt. % ceria (e.g., 5 wt. % to 99 wt. %, or 10 wt. % to 95 wt. % ceria), from 1 wt. % to 99 wt. % cellulose ether (e.g., 1 wt. % to 90 wt. %, or 1 wt. % to 50 wt. %, or 1 wt. % to 20 wt. % cellulose ether), and optionally from 0 wt. % to 20 wt. % solvent (e.g., 1 wt. % to 15 wt. %, or 1 wt. % to 10 wt. %, or 1 wt. % to 7 wt. % solvent). The percentages by weight being expressed with respect to the total quantity of compounds and/or powders in the mixture and the sum of the quantities of each of the compounds and the powders in the mixture being equal to 100%. In some embodiments, the mixture includes from 20 wt. % to 70 wt. % solids, based on the total weight of the ceria extrudate mixture.

A process for the production a porous, extruded ceria-based material may optionally further comprise a mulling step to reduce the presence of larger particles that may not be readily extruded, or the presence of which would otherwise compromise the physical properties of the resulting extrudate. Any suitable mulling or kneading apparatus may be used. Mulling is typically undertaken for a period of from 3 min to 90 min (e.g., 5 min to 30 min). Mulling may suitably be undertaken over a range of temperatures, including ambient temperatures. A preferred temperature range for mulling is from 15° C. to 50° C. Mulling may suitably be undertaken at ambient pressures.

The step of mixing can be performed in any suitable manner including, such as dry blending the individual components and subsequently melt mixing in a mixer or mixing the components together directly in a mixer (e.g., a Banbury mixer, a Haake mixer, a Brabender internal mixer, high shear mixer, drum mixer) or a single or twin-screw extruder. In certain embodiments, the steps of mixing and extruding are simultaneous, such as when the ceria and the cellulose ether are mixed in the extruder and extruded. Alternatively, the ceria and the cellulose ether are mixed with the optional solvent before extrusion.

The ceria and the cellulose ether can be premixed as dry materials. The order of addition of the components (ceria, cellulose ether, optional solvent) will be a function of the targeted material. It is possible either to add the cellulose ether, ceria, and optional solvent in any order, the most suitable order is determined by the type of mixers employed.

Methods for producing the ceria extrudates of the present disclosure can involve agitating a mixture of ceria and the cellulosic binder to form a dough or paste that is suitable for extrusive processing. Agitation may occur by mulling in some instances. Mulling can be distinguished from milling in that mulling to does not apply a constant pressure and is gentler in terms of a lesser amount of force (energy) being applied during mixing.

Mixing may be accomplished by methods of materials processing and unit operations. If the mixing occurs in the liquid phase, stirring may be use, if the mass to be mixed is paste-like, kneading and/or extruding may be used and if the components to be mixed are all in a solid, powdery state, mixers may be used. The use of atomizers, sprayers, diffusers or nebulizers is conceivable as well, if the state of the components to be used allows the use thereof. For ceria materials that are paste-like or powder-like the use of static mixers, planetary mixers, mixers with rotating containers, pan mixers, pug mills, shearing-disk mixers, centrifugal mixers, sand mills, trough kneaders, internal mixers, internal mixers and continuous kneaders may be desired. A mixing process of mixing may also be sufficient to achieve the molding or extruding, such as when mixing and extruding coincide.

The mixing may take place in a continuous fashion or in batches. In the case where mixing is carried out in a batch, it may be carried out in a mixer equipped with Z arms, or with cams, or in another type of mixer, such as a planetary mixer. The mixing may provide a homogenous mixture of the pulverulent constituents.

Mixing may take place for a duration of 5 min to 60 min (e.g., 10 min to 50 min). The speed of rotation of the mixer arms may be 10 rpm to 75 rpm (e.g., 25 rpm to 50 rpm).

The mixture is then (or simultaneously) extruded. The extrusion may take place in a single or twin-screw ram extruder. In the case where a process of preparation is carried out continuously, the mixing may be couple with extrusion in one or more pieces of equipment. According to this implementation, the extrusion of the mixture, also called “kneaded paste”, may be carried out either by extruding directly at the end of a continuous mixer of the twin-screw type for example, or by connecting one or more batch mixers to an extruder. The geometry of the die, which gives the extrudates their shape, may be selected from any suitable die, such as cylindrical, multilobed, grooved shape, or slitted.

The extrusion may be affected by the quantity of solvent added in the mixing and may be adjusted to obtain a mixture or a paste that does not flow and is not overly dry, to allow its extrusion under suitable conditions of pressure dependent on the extrusion equipment used. In some embodiments, the extrusion is carried out at an extrusion pressure of about 1 MPa or more (e.g., 1 MPa to 20 MPa, or 2 MPa to 15 MPa, or 3 MPa to 10 MPa).

The extrudate is generally dried after it is formed. The drying operation generally removes most of the solvents (e.g., greater than 90%) from the extrudate but does not remove any organic material that might be present in the extrudate. Drying is usually performed at a temperature of 200° C. or less (e.g., 60° C. to 200° C., or 100° C. to 150° C., or 120° C. to 140° C.) for a time sufficient to dry the extrudate (e.g., at least 1 hour, 1 hour to 48 hours, or 1 hour to 24 hours, or 8 hours to 18 hours). Drying may be carried out at atmospheric pressure or under vacuum. The drying operation may occur in air or an inert atmosphere. Drying may suitably be conducted in a drying oven or in a box furnace, for example, under the flow of an inert gas at elevated temperatures.

The extrudate may also optionally undergo calcination to remove any solvent and at least partly decompose the organic matter used for facilitating the extruding of the mixture, and preferably to fully decompose the organic matter. Calcination may occur in an oxygen-containing gas (e.g., oxygen, air, oxygen-enriched air, and the like) at a temperature of at least 400° C. (e.g., 400° C. to 850° C., or 500° C. to 700° C.) for any suitable amount of time (e.g., 1 hour to 6 hours, or 1 hour to 4 hours). Calcination may be performed by any method known to those of skill in the art, for example in a fluidized bed or a rotary kiln.

The extrudate may be shaped as a rod, a ribbed rod, a tablet, a ring, an annular tablet, a sphere, a pellet, a honeycomb body, or a granule. Nominal sizes of the extrudates may vary. The diameter usually ranges from 0.5 mm to 6 mm (e.g., 0.75 mm to 4 mm, or 1 mm to 3 mm).

Once prepared, the extrudates may be subjected to a deposition step in which one or more catalytically active metals are deposited thereon. Deposition of the metal can occur by any means known in the art (e.g., impregnation of the extrudate to incipient wetness with an aqueous solution of the desired catalytically active metal or precursor compound). Representative metals include alkali metals, alkaline earth metals, transition metals, and rare earth metals.

### Properties of the Ceria Extrudate

Ceria extrudates of the present disclosure may have a crush strength (ASTM D6175) of 3.0 lb-force or more (e. g., 3.0 lb-force to 20.0 lb-force, or 5.0 lb-force to 15.0 lb-force, or 5.0 lb-force to 12.0 lb-force, or 8.0 lb-force to 12.0 lb-force).

Ceria extrudates of the present disclosure may have a BET surface area (ASTM D3663) of 50 m²/g or more (e.g., 50 m2/g to 4000 m²/g, or 300 m²/g to 4000 m²/g, or 500 m²/g to 1500 m²/g).

Ceria extrudates of the present disclosure may have a total pore volume (ASTM D3663) of 0.3 cm³/g or more (e.g., 0.3 cm³/g to 1.6 cm³/g, or 0.3 cm³/g to 1.4 cm³/g, or 0.3 cm³/g to 1.2 cm³/g, or 0.3 cm³/g to 1.0 cm³/g, or 0.4 cm³/g to 1.6 cm³/g, 0.4 cm³/g to 1.4 cm³/g, or 0.4 cm³/g to 1.2 cm³/g, or 0.4 cm³/g to 1.0 cm³/g).

Ceria extrudates of the present disclosure may have an average pore diameter size (ASTM D4365) of from 1 Å or more (e.g., 1 Å to 40 Å, or 2 Å to 25 Å, or 5 Å to 20 Å).

### Applications

Ceria extrudates of the present disclosure may be applied in any process in which a ceria-based catalyst can be used or required. The ceria extrudate can be suitably used, for example, as carrier for catalysts which are normally used for catalytic conversion of carbon dioxide to value-added chemicals such as dry reforming of methane (CH₄+CO₂→2CO+H₂), CO₂ hydrogenation (CO₂+H₂→CO+H₂O), reverse water-gas shift reaction (CO₂+4H₂O→CH₄+2H₂O), and formic acid synthesis (CO₂(aq)+H₂(aq)→HCOOH).

### EXAMPLES

The following examples are illustrative and are intended to be non-limiting.

Two recently published methods to prepare ceria-based extrudate catalysts were selected for evaluation. A METHOCEL-based method was also evaluated. All additives were used at comparable dosages, around 5 wt. % to dry catalyst solids.

### Example 1 (Comparative)

A ceria-based extrudate was prepared according to the procedure of J. N. Kuhn et al. (Ind. Eng. Chem. Res. 2018, 57, 845-855) using guar gum as a binder and extrusion aid.

### Example 2 (Comparative)

A ceria-based extrudate was prepared according to the procedure of A-M. Azad et al. (Ind. Eng. Chem. Res. 2012, 51, 12796-12806) using combination of polyvinyl alcohol, starch, some proprietary anti-static additive (quaternary ammonium salt on silica), and ammonia.

### Example 3

80 g of cerium (IV) oxide (Alfa Aesar, nanopowder) was combined with 4 g of METHOCEL™ F4M hydroxypropyl methylcellulose (5 wt. % to cerium oxide) and mixed thoroughly to create a uniform mixture. This mixed powder was added, with continuous stirring, to 285 g of deionized water maintained at 90° C. The resulting slurry was mixed for an additional time, to eliminate any dry spots and achieve uniformity. The slurry was maintained at 90° C., with occasional mixing, until the total weight of the slurry was reduced to about 140 g. At this point, the mixture was transferred to the extruder and extruded via a 1/16 inch die. The extrudate was dried at 65-120° C. and calcined at 600° C. in dry air flow, to yield cerium oxide extruded base.

### Example 4

### Extrudate Evaluation

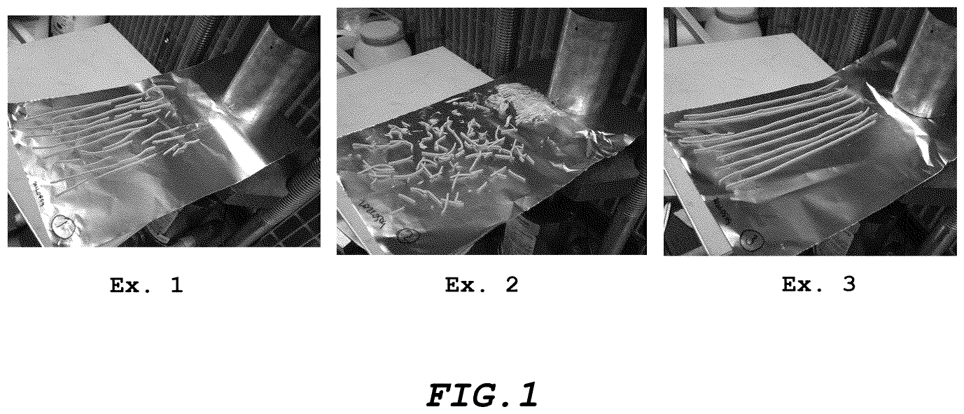

After drying at 200° C., the extrudates from Example 1 had barely acceptable mechanical strength, the extrudates from Example 2 were easily falling apart, and the extrudates from Example 3 had significantly higher strength that the other two. FIG. 1 shows photographs of ceria extrudates of Example 1, Example 2 and Example 3 after drying at 200° C.

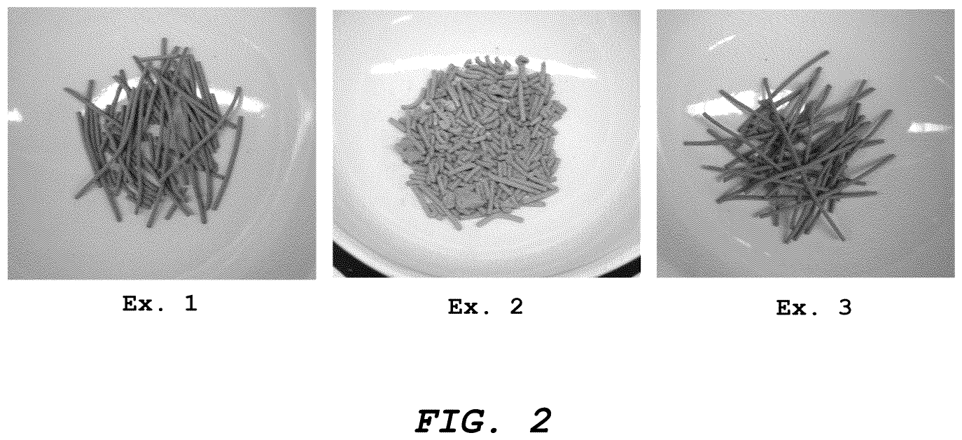

After calcination at 900° C., the mechanical strength of the extrudates had been reduced significantly, but it was still acceptable for the preparation of the test sized 25/40 mesh particles. FIG. 2 shows photographs of ceria extrudates of Example 1, Example 2 and Example 3 after calcination at 900° C. Extrudates prepared according to Example 3 worked best.

1. A process for preparing a porous, extruded ceria-based material, the process comprising:
(a) mixing ceria and a cellulose ether, and optionally a solvent, to form a mixture;
(b) extruding the mixture to form an extrudate; and
(c) drying and/or calcining the extrudate.

2. The process of claim 1, wherein the cellulose ether is selected from the group consisting of methylcellulose, hydroxypropyl cellulose, hydroxypropyl methylcellulose, hydroxyethyl cellulose, and carboxymethyl cellulose, any combination thereof.

3. The process of claim 1, wherein the cellulose ether comprises hydroxypropyl methylcellulose.

4. The process of claim 1, wherein the solvent comprises wherein the solvent is selected from the group consisting of water, alcohols, ketones, amides, esters, ethers, nitriles, aromatic hydrocarbons, aliphatic hydrocarbons, and any combination thereof.

5. The process of claim 1, wherein the mixture comprises from 20% to 70% by weight solids, based on a total weight of the mixture.

6. The process of claim 1, wherein the drying of the extrudate is conducted at a temperature in a range of from 60° C. to 200° C. for a time sufficient to dry the extrudate.

7. The process of claim 1, wherein the calcining of the extrudate is conducted in an oxygen-containing gas at a temperature in a range of from 400° C. to 850° C. for a time of from 1 to 6 hours.

8. A porous, extruded ceria-based material obtainable by the process of claim 1.

9. The porous, extruded ceria-based material of claim 8, having a crush strength of 3.0 lb-force or more, as determined by ASTM D6175.

10. The porous, extruded ceria-based material according to claim 8, having a BET surface area of 50 m²/g or more, as determined by ASTM D3663.

11. The porous, extruded ceria-based material according to claim 8, having a total pore volume of 0.3 cm³/g or more, as determined by ASTM D3663.

12. The porous, extruded ceria-based material according to claim 8, having an average pore diameter size of from 1 Å to 40 Å, as determined by ASTM D4365.

13. The porous, extruded ceria-based material according to claim 8, wherein the material is shaped as a rod, a ribbed rod, a tablet, a ring, an annular tablet, a sphere, a pellet, a honeycomb body, or a granule.
